(19) United States
(12) Patent Application Publication
(10) Pub. No.: US 2026/0319203 A1
(43) Pub. Date: Oct. 15, 2026

(54) METHOD FOR MANUFACTURING ROLLABLE OPTICAL FIBRE RIBBONS AND CABLES AND ROLLABLE OPTICAL FIBRE RIBBONS AND CABLES THEREOF

(71) Applicant: VINDHYA TELELINKS LIMITED, Rewa (IN)

(72) Inventors: Ramesh Singh, Rewa (IN); Shrawan Mishra, Rewa (IN); Manish Parikh, Rewa (IN); Ankit Sharma, Rewa (IN)

(21) Appl. No.: 19/643,746

(22) Filed: Apr. 9, 2026

(51) Int. Cl. G02B 6/44

(52) U.S. Cl. CPC G02B 6/443; G02B 6/448; G02B 6/4482; G02B 6/4486; G02B 6/449

(57) ABSTRACT

The present disclosure relates to an optical fibre ribbon and an optical fibre cable incorporating the same, and to methods of manufacturing thereof. The optical fibre ribbon comprises a plurality of optical fibres arranged substantially parallel, and a plurality of bonding regions formed between adjacent fibres. The bonding regions are distributed intermittently along a longitudinal direction and arranged across a ribbon width to define a gradient bonding profile, wherein bond characteristics vary between edge portions and central portions. The bonding regions are formed using a bonding material including an acrylate, resin, or adhesive, and may be applied as discrete drops with controlled spacing and bond length. The ribbon is configurable between planar and rolled configurations and is suitable for high-density cable assemblies. The method includes forming the ribbon, curing the bonding material, arranging one or more ribbons within a cable core, and applying an outer sheath, optionally in a continuous or integrated process.

### FIELD OF THE INVENTION

The present disclosure relates to optical fibre cable technology, and more particularly to rollable optical fibre ribbon with gradient bonding and method of manufacturing thereof.

### BACKGROUND OF THE INVENTION

In recent years, the telecommunications and data networking industries have witnessed a growing demand for cables that can accommodate increasingly high fibre counts while maintaining flexibility, compactness, and ease of installation. Traditional planar fibre ribbons, while effective for mass splicing, have proven less than ideal for modern infrastructure requirements. As the industry pivots toward more space-efficient and flexible cabling solutions, rollable ribbon technology has emerged as a promising innovation.

In this evolving landscape, rollable ribbons offer the dual benefit of a collapsible geometry that can be tightly bundled for cable installation, while still allowing the fibres to be spread out into a planar array for efficient splice preparation. While these advancements mark a significant step forward, existing rollable ribbon designs still face challenges related to bonding integrity, including maintaining mechanical integrity during rolling and unrolling, ensuring stable fibre alignment under handling stresses, and stable fibre alignment.

In light of these industry trends and the limitations of current solutions, the present disclosure is directed toward an improved rollable ribbon optical fibre cable that enhances mechanical resilience, optimizes space utilization, and supports efficient manufacturability. This disclosure aims to provide a robust, reliable, and industry-leading solution aligned with the evolving needs of high-density fibre networks.

In practice, the stresses imposed on fibre interfaces are not uniform: certain interfaces experience higher bending and tensile loads, while others remain relatively unstressed. Conventional ribbons, with uniform bonding strength across all interfaces, are prone to localized fibre damage, delamination, or micro-bending losses during assembly and deployment.

In light of this drawback, there exists a need for an optical fibre cable that provides differentiated bonding strength across fibre interfaces, enabling controlled flexibility where needed and enhanced robustness where stresses are greatest. Such a design would ensure reliable performance during rolling, folding, and installation, while maintaining ease of fibre separation and minimizing optical loss. This improvement would overcome the limitations of conventional intermittently bonded ribbons and deliver a more resilient solution for high-density cable applications.

### SUMMARY OF THE INVENTION

The present disclosure relates to optical fibre cable technology, and more particularly to rollable optical fibre ribbon with gradient bonding and method of manufacturing thereof.

In an embodiment, an optical fibre ribbon comprising a plurality of optical fibres arranged substantially parallel to each other along a longitudinal direction and across a ribbon width; and a bonding material disposed between adjacent optical fibres to form a plurality of bonding regions, wherein the plurality of bonding regions are distributed intermittently along the longitudinal direction, and arranged across the ribbon width such that bonding regions at one or more edge portions have greater bond length than bonding regions at one or more central portions.

In another embodiment, a method of manufacturing an optical fibre cable, the method comprising arranging a plurality of optical fibres in a substantially parallel configuration along a longitudinal direction to form an optical fibre assembly; dispensing a bonding material between adjacent optical fibres to form a plurality of bonding regions; controlling deposition of the bonding material such that the bonding regions are distributed intermittently along the longitudinal direction and arranged across a ribbon width to provide greater bond length at one or more edge portions relative to one or more central portions, thereby forming a rollable optical fibre ribbon; curing the bonding material to secure the plurality of optical fibres in the rollable optical fibre ribbon; positioning at least one said optical fibre ribbon within a cable core; and enclosing the cable core within an outer sheath to form the optical fibre cable.

In another embodiment, an optical fibre cable comprising an outer sheath; and a cable core disposed within the outer sheath, the cable core comprising at least one optical fibre ribbon, wherein the at least one optical fibre ribbon comprises of a plurality of optical fibres arranged substantially parallel to each other along a longitudinal direction and across a ribbon width; and a bonding material disposed between adjacent optical fibres to form a plurality of bonding regions, wherein the plurality of bonding regions are distributed intermittently along the longitudinal direction, and arranged across the ribbon width such that bonding regions at one or more edge portions have greater bond length than bonding regions at one or more central portions.

An objective of the present disclosure is to provide a rollable optical fibre ribbon that overcomes the limitations of conventional fully bonded optical fibre ribbons and loose-fibre cable structures. In particularly, it is an object of the present disclosure to provide a rollable optical fibre ribbon with Gradient intermittent bonded Ribbon (GIBR).

Another objective of the present disclosure is to provide Gradient intermittent bonded Ribbon GIBR with optimized bond area and good mechanical strength, flexibility and rollability of the optical fibre.

Another objective of the present disclosure is to provide a manufacturing method for rollable ribbon optical fibre structure with gradient bonding, offering controlled flexibility and stability. Gradient bonding applies stronger adhesion at ribbon edges and lighter bonding at the center, enabling compact rolling without misalignment and easy expansion for splicing. This unique approach improves packing density, mechanical resilience, and environmental durability while supporting efficient, high-fibre-count manufacturing and mass fusion splicing.

Another object of the present disclosure is to provide an optical fibre ribbon that maintains precise fibre alignment suitable for mass fusion splicing while offering improved flexibility and bend performance.

Another object of the present disclosure is to provide an optical fibre ribbon having intermittent bonding locations that enable the ribbon to be rolled, folded, or collapsed for compact cable packaging and handling.

Another object of the present disclosure is to provide a rollable ribbon that allows higher fibre packing density within an optical fibre cable, thereby reducing overall cable diameter and weight.

Another object of the present disclosure is to provide a rollable optical fibre ribbon that can be manufactured using continuous, high-speed production with consistent results.

Another object of the present disclosure is to provide a rollable optical fibre ribbon that can transition between rolled and flat configurations without causing fibre damage, positional instability, or permanent deformation.

Another object of the present disclosure is to provide a rollable optical fibre ribbon suitable for use in telecommunications networks, data centers, and access networks, including high-fibre-count cable applications.

Another object of the present disclosure is to provide a rollable ribbon structure that is cost-effective, mechanically robust, and compatible with existing cable designs and splicing tools.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a rollable optical fibre ribbon with gradient intermittent bonding, in accordance with an aspect of the present disclosure;

FIG. 2 illustrates a rollable optical fibre ribbon with gradient intermittent bonding, in accordance with another aspect of the present disclosure;

FIG. 3 illustrates a rollable optical fibre ribbon with gradient intermittent bonding, in accordance with another aspect of the present disclosure;

FIG. 4 illustrates a rollable optical fibre ribbon with gradient intermittent bonding, in accordance with another aspect of the present disclosure;

FIG. 5 illustrates a rollable optical fibre ribbon with gradient intermittent bonding, in accordance with another aspect of the present disclosure;

FIG. 6 illustrates a rollable optical fibre ribbon with gradient intermittent bonding, in accordance with another aspect of the present disclosure;

FIG. 7 illustrates a diagrammatic representation of a typical procedure for assembling an optical-fibre ribbon with 8 or 12 or 16 fibres;

FIG. 8 illustrates an optical fibre cable, in accordance with another aspect of the present disclosure;

FIG. 9 illustrates an optical fibre cable, in accordance with another aspect of the present disclosure; and

FIG. 10 illustrates a flow chart for a method for manufacturing an optical fiber cable in accordance with another aspect of the present disclosure

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a method or method that comprises a list of steps does not include only those steps but may include other steps not expressly listed or inherent to such method or methods. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

In the present disclosure, the term “gradient bonding” refers to a spatial variation in one or more bonding parameters across the width of the optical fibre ribbon, including but not limited to bond length, bond size, bond volume, or bonding strength, such that bonding regions at edge portions of the ribbon differ from bonding regions at central portions.

The term “intermittent bonding” refers to a discontinuous arrangement of bonding regions along the longitudinal direction of the optical fibre ribbon, wherein discrete bonding regions are separated by unbonded sections.

Embodiments of the present disclosure will be described below in detail concerning the accompanying drawings.

The present disclosure relates to a rollable optical fibre ribbon comprising optical fibres arranged in a parallel configuration and bonded together at intermittent bonding locations along a longitudinal direction of the fibres. The intermittent bonding locations are configured to maintain alignment of the optical fibres while allowing the ribbon to be rolled, folded, or collapsed for compact packaging and handling. The disclosed rollable optical fibre ribbon is capable of transitioning between a flat configuration suitable for ribbon splicing and a rolled or compact configuration suitable for high-density cable installation, without causing permanent deformation or damage to the optical fibres. The disclosure further encompasses bonding patterns, materials, and manufacturing methods for forming the gradient intermittent bonded locations, including spot bonding, patterned bonding, and selective adhesive application followed by curing. The rollable optical fibre ribbon disclosed herein is suitable for incorporation into high-fibre-count optical fibre cables used in telecommunications networks, data centers, and access networks, and provides improved flexibility, packing density, and compatibility with mass fusion splicing techniques.

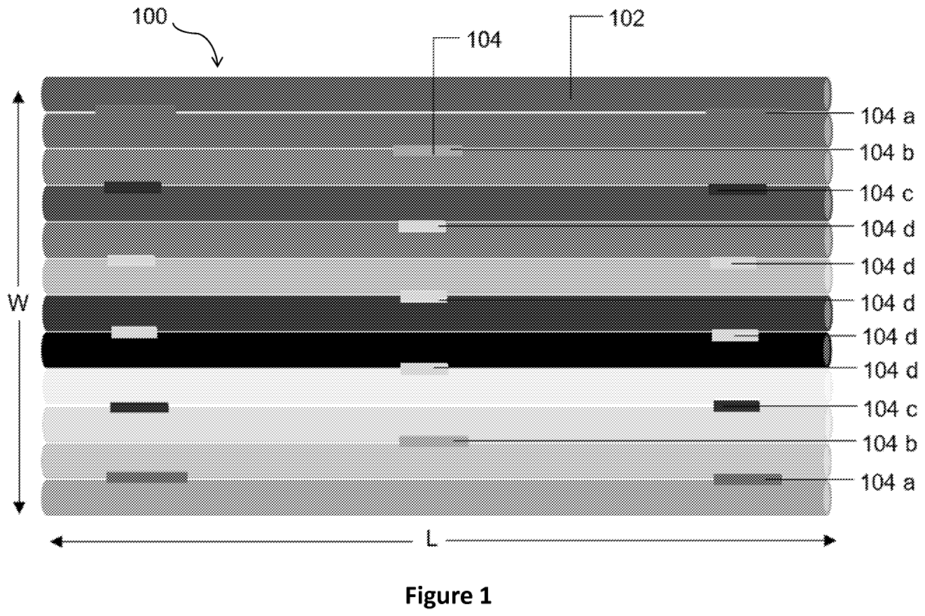

FIG. 1 illustrates a rollable optical fibre ribbon with gradient intermittent bonding, in accordance with an aspect of the present disclosure. FIG. 1 depicts a rollable optical fibre ribbon (100) comprising a plurality of optical fibres (102) arranged substantially parallel to one another along a longitudinal direction (L) and across a ribbon width (W).

In an embodiment, the optical-fibre ribbon comprises a plurality of coloured optical fibres aligned with predefined colour sequence, secured in a substantially parallel arrangement with a matrix material. Such ribbons are incorporated into optical-fibre cables designed to achieve high fibre counts within limited installation space. The optical-fibre ribbon (100) exhibits mechanical robustness, enabling it to withstand handling and manufacturing operations due to its high mechanical strength. Furthermore, the optical-fibre ribbon 100 possesses flexibility, allowing it to be rolled or folded with ease. The optical-fibre ribbon (100) comprises a plurality of optical fibres (102) and a plurality of gradiently varying length bonds (104). The optical fibres (102) are disposed substantially parallel to one another to maintain the substantially planar configuration of the ribbon. In certain embodiments, the ribbon may include 12 fibres (as illustrated in FIG. 1). In alternative embodiments, the ribbon may include 8 fibres or 16 fibres. More generally, the number of optical fibres (102) incorporated within the ribbon 100 may vary depending on design requirements. Each of the plurality of optical fibres 102 in the optical-fibre ribbon (100) has a diameter 252±10 microns. In certain embodiments, the fibres may have a diameter 202±10 microns. More generally, the diameter of the optical fibres (102) may be selected from any suitable range 160 micron to 260 micron, depending on design and application requirements. The plurality of gradiently varying length bonds (104) is placed in a periodic manner along a longitudinal length on single side of the optical fibre ribbon (100). Each bond is followed by an unbonded portion. The plurality of bonds (104) are arranged in predefined pattern and controlled by a computer-controlled algorithm. The distance between bonds (104) the same pair of fibres will be 70 mm to 90 mm, distance of bonds (104) between adjacent pairs will be 30 mm to 50 mm. The bond lengths are in gradient manner across the width of the ribbon having the longest bond at the edge fibre pairs and shortest bonds at the centre pair. The bond lengths varied between 8 mm to 15 mm across the width of the rollable ribbon. The rollable ribbon being discussed allows the spread out of the GIBR from 135 mm to 235 mm without bond/fibre breakage besides being highly flexible and easily rollable.

In another embodiment, an optical fibre ribbon (100) comprising a plurality of optical fibres (102) arranged substantially parallel to each other along a longitudinal direction (L) and across a ribbon width (W); and a bonding material disposed between adjacent optical fibres to form a plurality of bonding regions (104), wherein the plurality of bonding regions (104) are distributed intermittently along the longitudinal direction (L), and arranged across the ribbon width (W) such that bonding regions (104) at one or more edge portions have greater bond length than bonding regions at one or more central portions.

In another embodiment, the bond length of the bonding regions (104) progressively varies across the ribbon width (W) from the edge portions toward the central portions.

In another embodiment, the bonding regions (104) at the edge portions have a maximum bond length and the bonding regions (104) at the central portions have a minimum bond length.

In another embodiment, bond lengths of the bonding regions (104) are selected within a range of 8 mm to 15 mm.

In another embodiment, bonding strength between adjacent fibres at the edge portions is greater than bonding strength between adjacent fibres at the central portions.

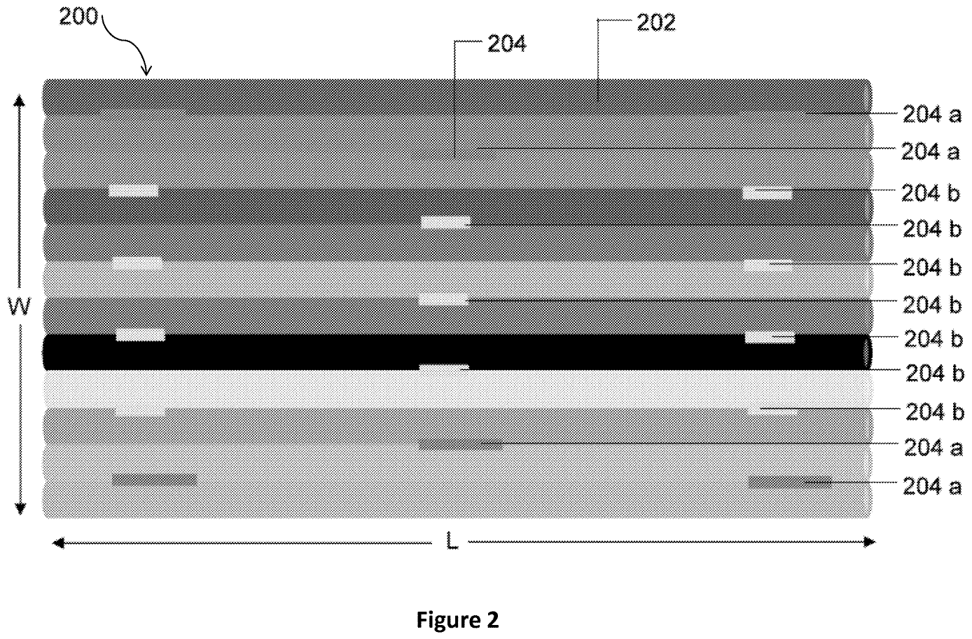

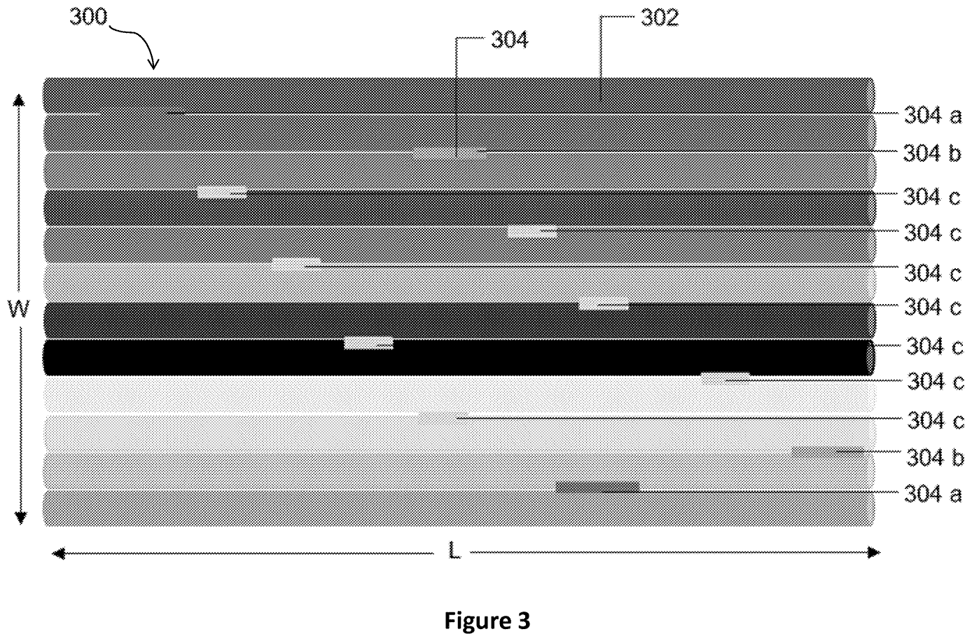

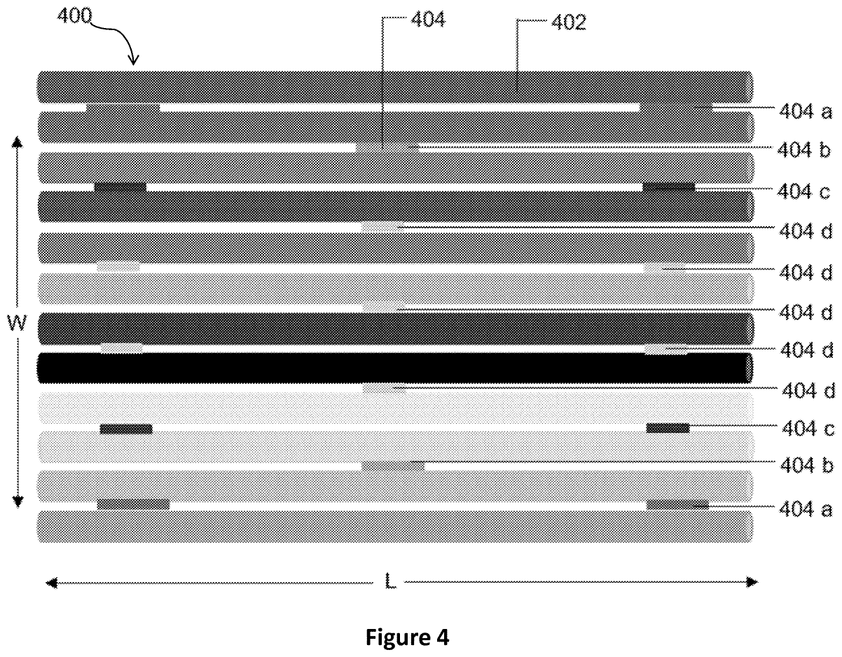

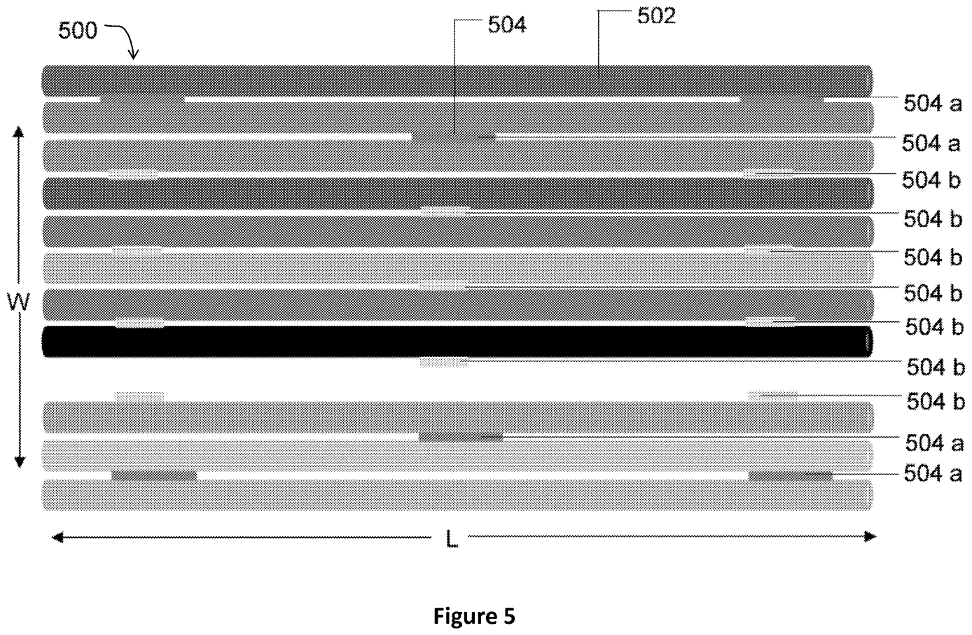

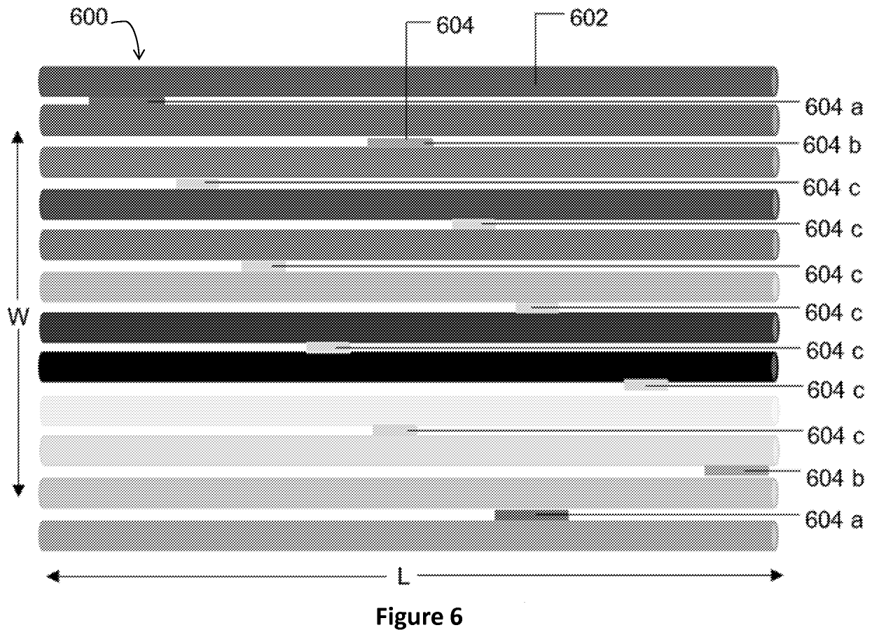

In another embodiment, spacing between consecutive bonding regions along a longitudinal direction for a same pair of adjacent fibres is selected from a first range of 70 mm to 90 mm or a second range of 105 mm to 115 mm. For Example, 70 mm to 90 mm for FIG. 1, FIG. 2, FIG. 4 & FIG. 5 and 105 mm to 115 mm for FIG. 3 & FIG. 6.

In another embodiment, bond lengths of the bonding regions (104) across the ribbon width are non-uniform such that each bonding region has a bond length different from at least one adjacent bonding region.

In an embodiment, the bond lengths of the bonding regions across the ribbon width are gradiently varied such that each bonding regions at one or more edge portions have greater bond length than bonding regions at one or more central portions.

In another embodiment, spacing between bonding regions (104) of adjacent fibre pairs along the longitudinal direction (L) is in a first range of 30 mm to 50 mm or a second range of 50 mm to 60 mm. For Instance, for the first range is a first range of 30 mm to 50 mm for FIG. 1, FIG. 2, FIG. 4 & FIG. 5 and the second range is 50 mm to 60 mm for FIG. 3 & FIG. 6.

In another embodiment, the bonding material comprises an acrylate, matrix resin, adhesive, or a combination thereof.

In another embodiment, the bonding regions (104) are formed on a single side of the optical fibre ribbon.

In another embodiment, each of the plurality of optical fibres (102) comprises a coloured ink coating layer.

In another embodiment, the plurality of optical fibres (102) comprises 8 to 16 optical fibres.

In another embodiment, each optical fibre (102) has a diameter in a range of 160 μm to 260 μm.

In another embodiment, the bonding regions (104) are formed as discrete drops of the bonding material.

In another embodiment, the bonding regions (104) are arranged in a predefined pattern across the ribbon width.

In another embodiment, adjacent optical fibres are spaced apart by a predefined gap. In an embodiment, the bonding regions are configured to provide a non-uniform bonding profile across the ribbon width such that bonding characteristics between adjacent optical fibres vary between edge portions and central portions of the optical fibre ribbon; wherein the bonding regions are further arranged in a spatially varying pattern along the longitudinal direction such that bonding positions between adjacent fibre pairs are non-aligned; wherein the non-uniform bonding profile is configured to: provide relatively higher mechanical stability at one or more edge portions of the optical fibre ribbon, and provide relatively greater flexibility at one or more central portions of the optical fibre ribbon, such that the optical fibre ribbon is deformable between a rolled configuration and a substantially planar configuration while maintaining fibre alignment.

In an embodiment, the optical fibres located in central portions of the optical fibre ribbon are separable from adjacent fibres with lower force relative to optical fibres located in edge portions due to a non-uniform bonding profile, and wherein each bonding region is followed by an unbonded segment along the longitudinal direction, and wherein a ratio of the bonded length to unbonded length varies between different fibre pairs across the ribbon width.

In an embodiment, the adjacent optical fibres are separated by a predefined gap, and bonding regions are selectively formed only at discrete locations without filling the predefined gap along an entire longitudinal length, and wherein a non-uniform bonding profile redistributes mechanical stress during bending and twisting such that higher stresses are absorbed at edge portions and reduced stresses are experienced at central portions.

In an embodiment, the bonding regions are formed from the bonding material having a controlled viscosity such that each bonding region is confined to an intended interface between adjacent optical fibres and does not extend into neighbouring fibre interfaces, and wherein bonding strength between adjacent optical fibres varies based on interaction between a cured bonding material and a curing state of a coating layer on the optical fibres, such that partially cured coating layers provide higher adhesion than substantially fully cured coating layers.

In an embodiment, the each bonding region is followed by an unbonded segment along the longitudinal direction, and wherein a ratio of the bonded length to unbonded length varies between different fibre pairs across the ribbon width such that fibre pairs at central portions have a lower bonded-to-unbonded ratio than fibre pairs at edge portions.

In an exemplary embodiment, the optical fibre ribbon (100) comprises twelve optical fibres (12F), although the number of fibres may vary depending on design requirements, typically 8F, 12F & 16F. Each of the plurality of optical fibres (102) is provided with an identification marking. In certain embodiments, the identification marking may be implemented using colour coding, including but not limited to blue, orange, green, brown, slate, white, red, black, yellow, violet, rose, and aqua.

A plurality of bonding regions (104) is disposed between adjacent optical fibres (102). The bonding regions (104) comprise a bonding material selected from an acrylate, matrix material, adhesive, or a combination thereof. The bonding regions (104) are arranged intermittently along the longitudinal direction (L) of the optical fibre ribbon (100), such that each bonding region is separated by an unbonded segment.

In an embodiment, spacing between consecutive bonding regions (104) along a same pair of adjacent optical fibres is in a range of 70 mm to 90 mm. Further, spacing between bonding regions (104) of adjacent fibre pairs is in a range of 30 mm to 50 mm, thereby forming a staggered bonding configuration.

The bonding regions (104) are configured to exhibit a gradient bond length profile across the ribbon width (W). In particular, bond lengths vary between edge portions and central portions of the optical fibre ribbon (100). In an exemplary configuration, the bond lengths include:
approximately 14 mm (104a) at edge portions,
approximately 12 mm (104b) at intermediate positions adjacent to the edges,
approximately 10 mm (104c) at positions further inward, and
approximately 8 mm (104d) at central portions of the ribbon.

In an exemplary implementation, within a 5-meter length of the optical fibre ribbon (100), the number of bonding regions may include approximately 125 bonding regions of type (104a), 125 bonding regions of type (104b), 125 bonding regions of type (104c), and 312 bonding regions of type (104d). It will be understood that these values are illustrative and may vary based on design and manufacturing parameters. The variation in bond length across the ribbon width (W) defines a gradient bonding configuration.

FIG. 2 depicts a rollable optical fibre ribbon (200) comprising a plurality of optical fibres (202) arranged substantially parallel to one another along a longitudinal direction (L) and across a ribbon width (W). In an exemplary embodiment, the optical fibre ribbon (200) comprises twelve optical fibres (12F), although the number of fibres may vary, typically 8F, 12F & 16F.

Each of the plurality of optical fibres (202) may include identification markings. In certain embodiments, such identification may be provided using colour coding, including but not limited to blue, orange, green, brown, slate, white, red, black, yellow, violet, rose, and aqua.

A plurality of bonding regions (204) is disposed between adjacent optical fibres (202). The bonding regions (204) comprise a bonding material selected from an acrylate, matrix material, adhesive, or combinations thereof. The bonding regions (204) are arranged intermittently along the longitudinal direction (L), such that bonded portions are separated by unbonded segments.

In an embodiment, spacing between consecutive bonding regions (204) along a same pair of adjacent optical fibres is in a range of 70 mm to 90 mm. Further, spacing between bonding regions (204) of adjacent fibre pairs is in a range of 30 mm to 50 mm, thereby forming a staggered bonding configuration.

The bonding regions (204) are arranged across the ribbon width (W) to define a gradient bonding profile. In this embodiment, the gradient profile is defined by two distinct bond lengths, including:
approximately 14 mm (204a) at one or more edge portions of the ribbon, and
approximately 8 mm (204b) at one or more central portions of the ribbon.

In an exemplary implementation, within a 5-meter length of the optical fibre ribbon (200), the number of bonding regions may include approximately 250 bonding regions of type (204a) and approximately 437 bonding regions of type (204b). These values are illustrative and may vary depending on design and manufacturing conditions.

FIG. 3 depicts a rollable optical fibre ribbon (300) comprising a plurality of optical fibres (302) arranged substantially parallel to one another along a longitudinal direction (L) and across a ribbon width (W). In an exemplary embodiment, the optical fibre ribbon (300) comprises twelve optical fibres (12F), although the number of fibres may vary depending on design requirements, typically 8F, 12F & 16F.

Each of the plurality of optical fibres (302) may include identification markings. In certain embodiments, such identification may be provided using colour coding. It will be appreciated that, in patent drawings, colour distinctions may be represented using gray scale shading, patterns, or other visual differentiation techniques, and the colour description is provided for identification purposes only.

A plurality of bonding regions (304) is disposed between adjacent optical fibres (302). The bonding regions (304) comprise a bonding material selected from an acrylate, matrix material, adhesive, or combinations thereof. The bonding regions (304) are arranged intermittently along the longitudinal direction (L), such that bonded portions are separated by unbonded segments.

In an embodiment, spacing between consecutive bonding regions (304) along a same pair of adjacent optical fibres is in a range of 105 mm to 115 mm. Further, spacing between bonding regions (304) of adjacent fibre pairs is in a range of 50 mm to 60 mm, thereby forming a staggered bonding configuration.

The bonding regions (304) are arranged across the ribbon width (W) to define a gradient bonding profile. In this embodiment, the gradient profile is defined by three distinct bond lengths, including:
approximately 14 mm (304a) at one or more edge portions of the ribbon,
approximately 12 mm (304b) at intermediate portions adjacent to the edge portions, and
approximately 8 mm (304c) at one or more central portions of the ribbon.

In an exemplary implementation, within a 5-meter length of the optical fibre ribbon (300), the number of bonding regions may include approximately 91 bonding regions of type (304a), 91 bonding regions of type (304b), and 318 bonding regions of type (304c). These values are illustrative and may vary depending on design and manufacturing conditions.

FIG. 4 depicts a rollable optical fibre ribbon (400) comprising a plurality of optical fibres (402) arranged substantially parallel to one another along a longitudinal direction (L) and across a ribbon width (W). In an exemplary embodiment, the optical fibre ribbon (400) comprises twelve optical fibres (12F), although the number of fibres may vary, typically 8F, 12F & 16F. In this embodiment, adjacent optical fibres (402) are arranged with a predefined spacing or gap between neighbouring fibres, thereby defining a spaced ribbon configuration. Such spacing facilitates flexibility and splice compatibility with 250-micron fibre of the ribbon during handling and deployment.

Each of the plurality of optical fibres (402) may include identification markings. In certain embodiments, such identification may be provided using colour coding, including but not limited to blue, orange, green, brown, slate, white, red, black, yellow, violet, rose, and aqua.

A plurality of bonding regions (404) is disposed between adjacent optical fibres (402). The bonding regions (404) comprise a bonding material selected from an acrylate, matrix material, adhesive, or combinations thereof. The bonding regions (404) are arranged intermittently along the longitudinal direction (L), such that bonded portions are separated by unbonded segments.

In an embodiment, spacing between consecutive bonding regions (404) along a same pair of adjacent optical fibres is in a range of 70 mm to 90 mm. Further, spacing between bonding regions (404) of adjacent fibre pairs is in a range of 30 mm to 50 mm, thereby forming a staggered bonding configuration.

The bonding regions (404) are arranged across the ribbon width (W) to define a gradient bonding profile. In this embodiment, the gradient profile is defined by four distinct bond lengths, including:
approximately 14 mm (404a) at one or more edge portions of the ribbon,
approximately 12 mm (404b) at intermediate portions adjacent to the edges,
approximately 10 mm (404c) at positions further inward, and
approximately 8 mm (404d) at one or more central portions of the ribbon.

In an exemplary implementation, within a 5-meter length of the optical fibre ribbon (400), the number of bonding regions may include approximately 125 bonding regions of type (404a), 125 bonding regions of type (404b), 125 bonding regions of type (404c), and 312 bonding regions of type (404d). These values are illustrative and may vary depending on design and manufacturing conditions.

FIG. 5 depicts a rollable optical fibre ribbon (500) comprising a plurality of optical fibres (502) arranged substantially parallel to one another along a longitudinal direction (L) and across a ribbon width (W). In an exemplary embodiment, the optical fibre ribbon (500) comprises twelve optical fibres (12F), although the number of fibres may vary, typically 8F, 12F & 16F.

In this embodiment, adjacent optical fibres (502) are arranged with a predefined spacing or gap between neighbouring fibres, thereby defining a spaced ribbon configuration. Each of the plurality of optical fibres (502) may include identification markings. In certain embodiments, such identification may be provided using colour coding, including but not limited to blue, orange, green, brown, slate, white, red, black, yellow, violet, rose, and aqua. A plurality of bonding regions (504) is disposed between adjacent optical fibres (502). The bonding regions (504) comprise a bonding material selected from an acrylate, matrix material, adhesive, or combinations thereof. The bonding regions (504) are arranged intermittently along the longitudinal direction (L), such that bonded portions are separated by unbonded segments.

In an embodiment, spacing between consecutive bonding regions (504) along a same pair of adjacent optical fibres is in a range of 70 mm to 90 mm. Further, spacing between bonding regions (504) of adjacent fibre pairs is in a range of 30 mm to 50 mm, thereby forming a staggered bonding configuration.

The bonding regions (504) are arranged across the ribbon width (W) to define a gradient bonding profile. In this embodiment, the gradient profile is defined by two distinct bond lengths, including:
approximately 14 mm (504a) at one or more edge portions of the ribbon, and
approximately 8 mm (504b) at one or more central portions of the ribbon.

In an exemplary implementation, within a 5-meter length of the optical fibre ribbon (500), the number of bonding regions may include approximately 250 bonding regions of type (504a) and approximately 437 bonding regions of type (504 b). These values are illustrative and may vary depending on design and manufacturing conditions.

FIG. 6 depicts a rollable optical fibre ribbon (600) comprising a plurality of optical fibres (602) arranged substantially parallel to one another along a longitudinal direction (L) and across a ribbon width (W). In an exemplary embodiment, the optical fibre ribbon (600) comprises twelve optical fibres (12F), although the number of fibres may vary depending on design requirements, typically 8F, 12F & 16F.

In this embodiment, adjacent optical fibres (602) are arranged with a predefined spacing or gap between neighbouring fibres, thereby defining a spaced ribbon configuration. Each of the plurality of optical fibres (602) may include identification markings. In certain embodiments, such identification may be provided using colour coding, including but not limited to blue, orange, green, brown, slate, white, red, black, yellow, violet, rose, and aqua. It will be appreciated that, in patent drawings, such colour distinctions may be represented using gray scale shading, patterns, or other visual differentiation techniques, and the colour description is provided for identification purposes only.

A plurality of bonding regions (604) is disposed between adjacent optical fibres (602). The bonding regions (604) comprise a bonding material selected from an acrylate, matrix material, adhesive, or combinations thereof. The bonding regions (604) are arranged intermittently along the longitudinal direction (L), such that bonded portions are separated by unbonded segments.

In an embodiment, spacing between consecutive bonding regions (604) along a same pair of adjacent optical fibres is in a range of 105 mm to 115 mm. Further, spacing between bonding regions (604) of adjacent fibre pairs is in a range of 50 mm to 60 mm, thereby forming a staggered bonding configuration.

The bonding regions (604) are arranged across the ribbon width (W) to define a gradient bonding profile. In this embodiment, the gradient profile is defined by three distinct bond lengths, including:
approximately 14 mm (604a) at one or more edge portions of the ribbon,
approximately 12 mm (604b) at intermediate portions adjacent to the edge portions, and
approximately 8 mm (604c) at one or more central portions of the ribbon.

In an exemplary implementation, within a 5-meter length of the optical fibre ribbon (600), the number of bonding regions may include approximately 91 bonding regions of type (604a), 91 bonding regions of type (604b), and 318 bonding regions of type (604c). These values are illustrative and may vary depending on design and manufacturing conditions.

For purposes of illustration, it will be appreciated that, in patent drawings, such colour distinctions may be represented using gray scale shading, patterns, or other visual differentiation techniques, and the colour description is provided for identification purposes only. Further, the different bond lengths as referred in FIG. 1 to FIG. 6 may be represented using distinct visual indicators. In gray scale representations, such differences may be indicated by variations in size, shading, or pattern.

In an embodiment, a width of the optical fibre ribbon is determined based on a number of optical fibres and a diameter of each optical fibre arranged across the ribbon width.

In an exemplary configuration, the optical fibres may have an outer diameter of approximately 200 μm or 250 μm, and the ribbon may comprise 8, 12, or 16 optical fibres arranged in a substantially parallel configuration.

Further, the ribbon width may be approximated as a product of the number of optical fibres and the outer diameter of each optical fibre. By way of illustration:
for 8 optical fibres having a diameter of approximately 200 μm, the ribbon width is approximately 1.616 mm;
for 12 optical fibres having a diameter of approximately 200 μm, the ribbon width is approximately 2.424 mm;
for 16 optical fibres having a diameter of approximately 200 μm, the ribbon width is approximately 3.232 mm;
for 8 optical fibres having a diameter of approximately 250 μm, the ribbon width is approximately 2.016 mm;
for 12 optical fibres having a diameter of approximately 250 μm, the ribbon width is approximately 3.024 mm; and
for 16 optical fibres having a diameter of approximately 250 μm, the ribbon width is approximately 4.032 mm.

In another embodiment, an optical fibre cable comprising an outer sheath; and a cable core disposed within the outer sheath, the cable core comprising at least one optical fibre ribbon, wherein the at least one optical fibre ribbon comprises a plurality of optical fibres arranged substantially parallel to each other along a longitudinal direction and across a ribbon width; and a bonding material disposed between adjacent optical fibres to form a plurality of bonding regions, wherein the plurality of bonding regions are distributed intermittently along the longitudinal direction, and arranged across the ribbon width such that bonding regions at one or more edge portions have greater bond length than bonding regions at one or more central portions.

In an embodiment, the gradient intermittent bonded locations maintain relative alignment of the optical fibres while permitting unbonded sections between the bonding locations to allow the ribbon to transition between a substantially flat configuration and a rolled or collapsed configuration, and wherein the ribbon remains compatible with ribbon splicing.

The gradient intermittent bonded ribbon rollable optical fibre comprises 8-16 optical fibres. The gradient intermittent bonding pattern is selected to control flexibility, bend radius, or rollability of the ribbon. The gradient intermittent bonded locations are formed as spot bonds in a patterned bond. Adjacent gradient intermittent bonded locations are separated by unbonded flexible sections that allow relative movement of the optical fibres. The gradient intermittent bonded material comprises a UV-curable polymer, resin, adhesive, or a combination thereof. The gradient intermittent bonded material comprises a UV-curable polymer, resin, adhesive, or a combination thereof is able to separate individual fibres by hand or tool without any damage to fibre coating, no resin coating residue or cracks and without degrading optical performance. The gradient intermittent bonded ribbon provides good mechanical strength, flexibility & rollability of ribbon. The gradient intermittently bonded ribbon structure mitigates mechanical stress on individual fibres, thereby preventing fibre breakage during manufacturing. The gradient intermittent bonded ribbon mitigates mechanical stress on individual fibres, thereby preventing Bond breakage during manufacturing. The gradient intermittent bonded ribbon bond pattern is design to nullify stress on fibre during rollability.

The gradient intermittent bonded ribbon is capable of being rolled into a substantially cylindrical shape for compact cable packaging. The gradient intermittent bonded ribbon is configured to return from the rolled configuration to the flat configuration without permanent deformation. The gradient intermittent bonded ribbon is compatible with mass fusion splicing equipment.

A rollable optical fibre ribbon with gradient intermittent bonded ribbon rollable optical fibre ribbon has a height of maximum 260 microns. The individual coloured (for identification) fibre is under cured (75 to 95%) in a controlled manner. This controlled under-curing enhances chemical and mechanical interaction between the fibre coating and the GIBR bonding matrix/adhesive for uniform bond and bond strength.

In accordance with the present disclosure the rollable optical fiber ribbon as claimed, wherein in the gradient intermittent bonded ribbon, the controlled matrix flow methodology includes maintaining the bonding matrix at a processing temperature of approximately 70 °C±5 °C to regulate matrix viscosity within an optimized range. This controlled thermal management ensures consistent penetration and uniform distribution of the bonding matrix across fibre interfaces. As a result, the gradient intermittent bonded ribbon minimizing fibre stress during ribbon formation, uniform bond length and bond spacing along the longitudinal direction of the optical fibres, consistent bond strength across a width of the ribbon, improved mechanical integrity and enhanced flexibility and rollability during cabling, installation and handling. The force required to separate one optical fibre from the optical fibre ribbon is between 1.3 grams to 8.5 grams.

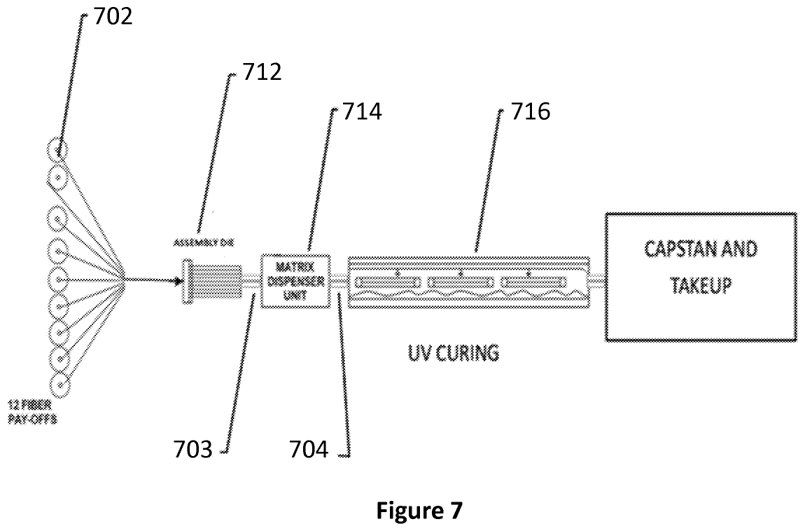

FIG. 7 illustrates a diagrammatic representation of a typical procedure for assembling an optical-fibre ribbon with 12 fibres. In one aspect, the present disclosure is directed to a method of manufacturing an optical-fibre ribbon, such as the optical-fibre ribbons (100-600) illustrated in FIGS. 1-6. Several steps of the method for producing are described herein with reference to the figures, including the process schematic depicted in FIG. 7, which collectively demonstrate the sequential steps of forming a longitudinal optical-fibre assembly, applying bonding acrylate/matrix/adhesive in intermittent patterns, and curing to achieve controlled gradient bonding strength and structural integrity of the resulting gradient optical-fibre ribbon.

A plurality of optical fibres 702 are fed, for example into a die (712), to form a longitudinal optical-fibre assembly (703) in which the fibres are substantially parallel and positioned adjacent to one another, as depicted in FIG. 7 (processing from left to right). The optical fibres are arranged in a parallel plane, each having a substantially circular cross-section and the colouring ink layer of the plurality of fibres may be partly cured, substantially fully cured, or completely cured, depending on the desired mechanical properties and processing requirements.

A UV/LED curable bonding acrylate/matrix/adhesive is dispensed, for example from a dispenser (714) or similar device, onto a surface such as the upper surface of the optical-fibre assembly (703), as depicted in FIG. 7. The application of the bonding acrylate/matrix/adhesive results in the formation of a plurality of intermittently arranged drops (704) along the upper surface of the optical-fibre assembly, thereby creating discrete coupling portions that provide controlled bonding between adjacent fibres while maintaining flexibility of the ribbon structure. The bonding acrylate/matrix/adhesive dispensing is done by a pre-programmed computerized algorithm ensuring the dispensing at desired location and varied length to ensure gradient bond

The optical-fibre assembly with drops applied thereon passes through a UV curing station (716) to cure the bonding acrylate/matrix/adhesive and, where the colouring ink layer is less than completely cured (e.g., partly cured or substantially fully cured), to further cure the colouring ink layer, as depicted in FIG. 7.

By way of non-limiting illustration, when the colouring ink layer is partly cured, concurrent curing of both resins enhances bonding strength between the bonding acrylate/matrix/adhesive and the colouring ink layer on the optical fibres. Conversely, when the colouring ink layer is substantially fully cured such that little further curing is possible, subsequent curing of the bonding acrylate/matrix/adhesive results in reduced bonding strength between the two resin layers. The relative strength of this coupling directly influences the robustness of the optical-fibre ribbon and the ease with which individual optical fibres may be separated from the ribbon. These two stage control over the curing process combined with the gradient bond, ensures the improved and varied mechanical strength needed at different fibre interfaces when the ribbon is rolled or folded.

The bonding acrylate/matrix/adhesive is heated and applied at a temperature of 65 °C to 75 °C. Processing temperature is selected in this precise range to ensure optimum viscosity of the bonding acrylate/matrix/adhesive so that the drops get properly dispersed in the intended interface of the two fibres and do not flow between the optical fibres.

The curing station (716) emits ultraviolet (UV) radiation to cure the drops of the bonding acrylate/matrix/adhesive applied to the optical-fibre assembly and, where applicable, to further cure the colouring ink layer forming the outer layer of the optical fibres, whether the colouring ink layer is partly cured or substantially fully cured, thereby ensuring controlled bonding strength and enhanced structural integrity of the gradient optical-fibre ribbon.

In another aspect, the present disclosure is directed to optical-fibre ribbon (100-600), such as those illustrated in FIGS. 1-6, with several details described herein with reference to the figures. In accordance with the present disclosure, the varied bonding strength between the optical fibres is achieved through controlled and varied dispensing of the bonding acrylate/matrix/adhesive using a pre-programmed computerized algorithm and the two-stage controlled curing. This combination results in the gradient intermittent bonded ribbon with varied mechanical strength needed at different fibre interfaces when the ribbon is rolled or folded.

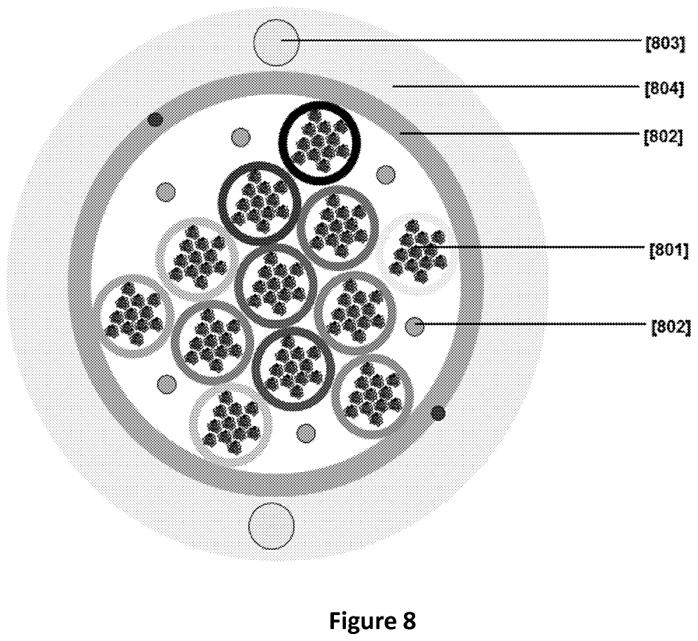

FIG. 8 illustrates an optical fibre cable, in accordance with another aspect of the present disclosure. The optical-fiber cable 800 comprises of a sheath layer 804, embedded strength member 803, Water blocking elements (tape and yarns) 802, an optical fibre core comprising plurality of optical fibre ribbons 801, corresponding to rollable optical fibre ribbon 100-600 of FIGS. 1-6. The plurality of rollable optical-fiber ribbons are rolled and then bundled together with simultaneous application of ultra-low shrinkage polyester identification yarn to form the cable core. The gradient bonded rollable ribbons enable the ribbon to be rolled into a compact cylindrical bundle for high-density packing within cable core, and subsequently expanded into a planar array for efficient mass fusion splicing. As another aspect of the present disclosure, the cable core formation and vacuum sheathing is carried out in a single integrated/tandem operation. Multiple rollable ribbon units are stranded in SZ (Clockwise/Anti-clockwise), and the protective sheathing system is applied simultaneously. This unified process ensures precise alignment and minimal distortion to the cable core geometry, uniform pressure distribution, and reduced manufacturing complexity, while enabling scalable fibre counts without redesigning the core geometry.

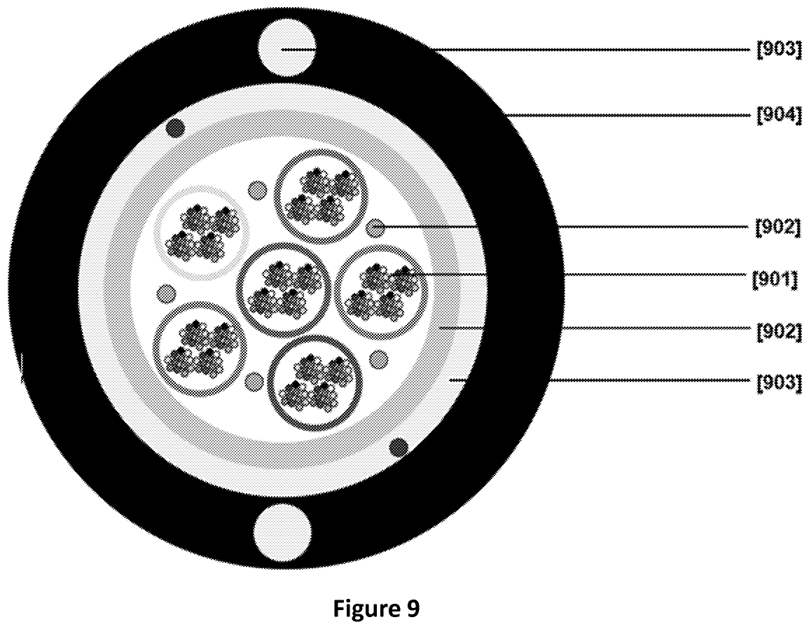

FIG. 9 illustrates an Optical fibre cable, in accordance with another aspect of the present disclosure. The optical-fiber cable 900 comprises of a sheath layer 904, embedded and peripheral strength member 903, Water blocking elements (tape and yarns) 902, an optical fibre core comprising plurality of optical fibre ribbons 901, corresponding to rollable optical fibre ribbon 100-600 of FIGS. 1-6. The plurality of rollable optical-fiber ribbons are rolled and then bundled together with simultaneous application of ultra-low shrinkage polyester identification yarn to form the cable core. The gradient bonded rollable ribbons enable the ribbon to be rolled into a compact cylindrical bundle for high-density packing within cable core, and subsequently expanded into a planar array for efficient mass fusion splicing. As another aspect of the present disclosure, the cable core formation and vacuum sheathing is carried out in a single integrated/tandem operation. Multiple rollable ribbon units are stranded in SZ (Clockwise/Anti-clockwise), and the protective sheathing system is applied simultaneously. This unified process ensures precise alignment and minimal distortion to the cable core geometry, uniform pressure distribution, and reduced manufacturing complexity, while enabling scalable fibre counts without redesigning the core geometry.

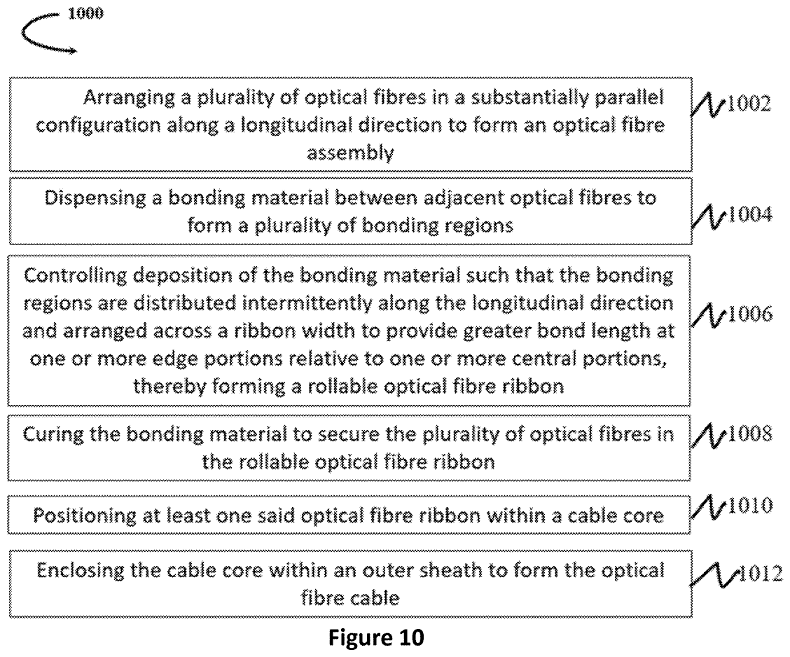

FIG. 10 illustrates a flow chart for a method of manufacturing an optical fibre cable including at least one optical fibre ribbon in accordance with another aspect of the present disclosure. The method 1000 comprising forming the at least one optical fibre ribbon and further the steps of:
Step 1002 discloses about arranging a plurality of optical fibres in a substantially parallel configuration along a longitudinal direction to form an optical fibre assembly;
Step 1004 discloses about dispensing a bonding material between adjacent optical fibres to form a plurality of bonding regions;
Step 1006 discloses about controlling deposition of the bonding material such that the bonding regions are distributed intermittently along the longitudinal direction and arranged across a ribbon width to provide greater bond length at one or more edge portions relative to one or more central portions, thereby forming a rollable optical fibre ribbon;
Step 1008 discloses about curing the bonding material to secure the plurality of optical fibres in the rollable optical fibre ribbon;
Step 1010 discloses about positioning at least one said optical fibre ribbon within a cable core; and
Step 1012 discloses about enclosing the cable core within an outer sheath to form the optical fibre cable.

In another embodiment, the method 100 further comprising stranding the plurality of rollable optical fibre ribbons in a helical pattern and applying coloured counter rotating binders of ultra shrinkage plastic over such stranded rollable ribbon units with extremely low and precisely controlled uniform tension in the range of 5-10 grams (gms). Arranging a plurality of said rollable optical fibre ribbons units within the cable core in alternating clockwise and anti-clockwise lay directions.

In another embodiment, the method 1000 further comprising enclosing the cable core within the outer sheath comprises applying the outer sheath simultaneously with formation of the cable core in one continuous operation.

In another embodiment, the cable core is formed by stranding a plurality of rollable optical fibre ribbons and the vacuum sheathing process is performed concurrently with the stranding operation.

In another embodiment, wherein controlling deposition of the bonding material is performed using a programmable control system configured to vary bond length across the ribbon width.

In another embodiment, the dispensing of the bonding material comprises depositing the bonding material as discrete drops on a single side of the optical fibre assembly.

In another embodiment, the bonding material is dispensed at an elevated temperature selected to control viscosity and control flow of the bonding material between adjacent optical fibres.

In another embodiment, wherein curing the bonding material comprises controlling curing conditions relative to a curing state of a coating layer on the optical fibres to vary bonding strength between adjacent optical fibres.

In another embodiment, the bonding material is dispensed at different temperatures for different bonding regions across the ribbon width to vary viscosity of the bonding material and to control bond length between edge portions and central portions.

In another embodiment, the bonding material is heated and dispensed at a temperature in a range of 65 °C to 75 °C.

In another embodiment, the method (1000) further comprising rolling and bundling the plurality of optical fibre ribbons together to form the cable core, and simultaneously applying a polyester identification yarn around the bundled optical fibre ribbons.

In another embodiment, the method (1000) further comprises at least one of: applying a water blocking material around the cable core; applying one or more strength yarns in and around the cable core; and optionally, embedding one or more strength members within the outer sheath during application of the outer sheath.

In another embodiment, the water blocking material is selected from a water-swellable yarn, water-swellable tape; the one or more strength yarns is selected from aramid yarn, glass yarn; and the one or more strength members is selected from fibre-reinforced plastic (FRP), aramid reinforced plastic (ARP), metallic rods.

The present disclosure provides a rollable optical fibre ribbon with gradient intermittent bonded ribbon [GIBR]. The rollable optical fibre ribbon includes an optical fibre. The optical fibres are placed parallel to each other, wherein the optical fibres adjacent to each other are gradient intermittently bonded along a length by a bonded portion.

The present disclosure discloses manufacturing method of rollable ribbon optical fibre structure incorporating a gradient bonding technique that provides superior flexibility, alignment stability, and environmental resilience compared to conventional ribbon designs.

In the disclosed structure, bonding strength is varied across the ribbon cross-section: edge fibres are bonded with higher adhesion to maintain positional stability, while central fibres are bonded with lower adhesion to permit controlled collapsibility. This gradient bonding enables the ribbon to be rolled into a compact cylindrical bundle for high-density packing within cable cores, and subsequently expanded into a planar array for efficient mass fusion splicing.

The present disclosure further introduces application of bonding matrix at variable temperature for changed viscosity in order to further support gradient bonding, ensuring consistent adhesion profiles across multiple fibre counts. This approach distributes mechanical stresses evenly, reducing fibre damage under bending and twisting, while also enhancing manufacturability and yield in high-fibre-count cable production. A two stage control over the curing process of colouring ink layer combined with the gradient bond ensures the improved and varied mechanical strength needed at different fibre interfaces when the ribbon is rolled or folded.

In addition to gradient bonding, the present disclosure discloses a tandem cable assembly and Vacuum sheathing process carried out in a single integrated operation. Multiple rollable ribbon units are arranged within cable core, stranded in SZ (Clockwise/Anti-clockwise), and the protective sheathing system is applied simultaneously. This unified process ensures precise alignment and minimal distortion to the cable core geometry, uniform pressure distribution, and reduced manufacturing complexity, while enabling scalable fibre counts without redesigning the core geometry.

Through this combination of gradient bonding, integrated tandem assembly and vacuum sheathing, the present disclosure delivers a rollable ribbon optical fibre cable that achieves high fibre density, superior durability, and compatibility with existing splicing practices, thereby meeting the evolving demands of next-generation optical networks.

The present disclosure pertains to a rollable optical fibre ribbon in which multiple optical fibres are arranged in a parallel configuration. Adjacent fibres are joined using a gradient bonding pattern across the width of the ribbon, with an identical intermittent bonding scheme applied along the longitudinal axis of the fibres.

This gradient rollable optical fibre ribbon provides a collapsible geometry, enabling the ribbon to be compactly bundled for cable installation. At the same time, the fibres can be readily expanded into a planar array, thereby facilitating efficient splice preparation without compromising fibre alignment or accessibility.

The present disclosure provides manufacturing method for rollable optical fibre ribbon with gradient intermittent bonding. Bonding strength is varied across the ribbon cross-section, i.e., edge fibres are bonded with higher adhesion to maintain positional stability, while central fibres are bonded with lower adhesion to permit controlled collapsibility.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. An optical fibre ribbon comprising:
a plurality of optical fibres arranged substantially parallel to each other along a longitudinal direction and across a ribbon width; and
a bonding material disposed between adjacent optical fibres to form a plurality of bonding regions,
wherein the plurality of bonding regions are distributed intermittently along the longitudinal direction, and arranged across the ribbon width such that bonding regions at one or more edge portions have greater bond length than bonding regions at one or more central portions, and wherein the bond length of bonding regions progressively varies across the ribbon width from the edge portions toward the central portions.

2. The optical fibre ribbon of claim 1, wherein the bonding regions at the edge portions have a maximum bond length and the bonding regions at the central portions have a minimum bond length.

3. The optical fibre ribbon of claim 1, wherein the bond length of the bonding regions are selected within a range of 8 mm to 15 mm.

4. The optical fibre ribbon of claim 1, wherein bonding strength between adjacent fibres at the edge portions is greater than bonding strength between the adjacent fibres at the central portions.

5. The optical fibre ribbon of claim 1, wherein spacing between consecutive bonding regions along the longitudinal direction for a same pair of adjacent fibres is selected from a first range of 70 mm to 90 mm or a second range of 105 mm to 115 mm.

6. The optical fibre ribbon of claim 1, wherein bond lengths of the bonding regions across the ribbon width are gradiently varied such that each bonding regions at the one or more edge portions have greater bond length than bonding regions at one or more central portions.

7. The optical fibre ribbon of claim 1, wherein spacing between bonding regions of adjacent fibre pairs along the longitudinal direction is in a first range of 30 mm to 50 mm or a second range of 50 mm to 60 mm.

8. The optical fibre ribbon of claim 1, wherein the bonding material comprises an acrylate, matrix resin, adhesive, or a combination thereof.

9. The optical fibre ribbon of claim 1, wherein the bonding regions are formed on a single side of the optical fibre ribbon, and wherein the bonding regions are formed as discrete drops of the bonding material.

10. The optical fibre ribbon of claim 1, wherein each of the plurality of optical fibres comprises a coloured ink coating layer, and wherein each optical fibre has a diameter in a range of 160 μm to 260 μm.

11. The optical fibre ribbon of claim 1, wherein the plurality of optical fibres comprises 8 to 16 optical fibres.

12. The optical fibre ribbon of claim 1, wherein the bonding regions are arranged in a predefined pattern across the ribbon width.

13. The optical fibre ribbon of claim 1, wherein adjacent optical fibres are spaced apart by a predefined gap.

14. The optical fibre ribbon of claim 1, wherein the bonding regions are configured to provide a non-uniform bonding profile across the ribbon width such that bonding characteristics between adjacent optical fibres vary between the edge portions and central portions of the optical fibre ribbon; wherein the bonding regions are further arranged in a spatially varying pattern along the longitudinal direction such that bonding positions between adjacent fibre pairs are non-aligned; wherein the non-uniform bonding profile is configured to: provide relatively higher mechanical stability at one or more edge portions of the optical fibre ribbon, and provide relatively greater flexibility at one or more central portions of the optical fibre ribbon, such that the optical fibre ribbon is deformable between a rolled configuration and a substantially planar configuration while maintaining fibre alignment.

15. The optical fibre ribbon of claim 1, wherein optical fibres located in central portions of the optical fibre ribbon are separable from adjacent fibres with lower force relative to optical fibres located in edge portions due to a non-uniform bonding profile, and wherein each bonding region is followed by an unbonded segment along the longitudinal direction, and wherein a ratio of the bonded length to unbonded length varies between different fibre pairs across the ribbon width.

16. The optical fibre ribbon of claim 1, wherein adjacent optical fibres are separated by a predefined gap, and bonding regions are selectively formed only at discrete locations without filling the predefined gap along an entire longitudinal length, and wherein a non-uniform bonding profile redistributes mechanical stress during bending and twisting such that higher stresses are absorbed at edge portions and reduced stresses are experienced at central portions.

17. The optical fibre ribbon of claim 1, wherein the bonding regions are formed from the bonding material having a controlled viscosity such that each bonding region is confined to an intended interface between adjacent optical fibres and does not extend into neighbouring fibre interfaces, and wherein bonding strength between adjacent optical fibres varies based on interaction between a cured bonding material and a curing state of a coating layer on the optical fibres, such that partially cured coating layers provide higher adhesion than substantially fully cured coating layers.

18. The optical fibre ribbon of claim 1, wherein each bonding region is followed by an unbonded segment along the longitudinal direction, and wherein a ratio of the bonded length to unbonded length varies between different fibre pairs across the ribbon width such that fibre pairs at central portions have a lower bonded-to-unbonded ratio than fibre pairs at edge portions.

19. A method of manufacturing an optical fibre cable including at least one optical fibre ribbon according to claim 1, the method comprising:
forming the at least one optical fibre ribbon by:
arranging a plurality of optical fibres in a substantially parallel configuration along a longitudinal direction to form an optical fibre assembly;
dispensing a bonding material between adjacent optical fibres to form a plurality of bonding regions;
controlling deposition of the bonding material such that the bonding regions are distributed intermittently along the longitudinal direction and arranged across a ribbon width to provide greater bond length at one or more edge portions relative to one or more central portions, thereby forming a gradient bonded rollable optical fibre ribbon; and
curing the bonding material to secure the plurality of optical fibres in the rollable optical fibre ribbon;
positioning at least one said optical fibre ribbon within a cable core; and
enclosing the cable core within an outer sheath to form the optical fibre cable.

20. The method of claim 19, further comprising:
stranding a plurality of optical fibre ribbons in a helical pattern and applying coloured counter rotating binders of ultra-shrinkage plastic over such stranded rollable ribbon units with extremely low and precisely controlled uniform tension in a range of 5-10 grams;
arranging a plurality of optical fibre ribbons within the cable core in alternating clockwise and anti-clockwise lay directions.

21. The method of claim 19, wherein said enclosing the cable core within the outer sheath comprises applying the outer sheath simultaneously with formation of the cable core in one continuous operation, and wherein the cable core is formed by stranding a plurality of rollable optical fibre ribbons and a vacuum sheathing process is performed concurrently with the stranding.

22. The method of claim 19, wherein said controlling of deposition of the bonding material is performed using a programmable control system configured to vary bond length across the ribbon width, and wherein said dispensing the bonding material comprises depositing the bonding material as discrete drops on a single side of the optical fibre assembly.

23. The method of claim 19, wherein the bonding material is dispensed at an elevated temperature selected to control viscosity and control flow of the bonding material between adjacent optical fibres, and wherein said curing the bonding material comprises controlling curing conditions relative to a curing state of a coating layer on the optical fibres to vary bonding strength between adjacent optical fibres.

24. The method of claim 19, wherein the bonding material is dispensed at different temperatures for different bonding regions across the ribbon width to vary viscosity of the bonding material and to control bond length between the one or more edge portions and central portions, and wherein the bonding material is heated and dispensed at a temperature in a range of 65 °C to 75 °C.

25. The method of claim 19, further comprising rolling and bundling a plurality of optical fibre ribbons together to form the cable core, and simultaneously applying coloured polyester identification yarns around bundled optical fibre ribbons.

26. The method of claim 19, further comprising at least one of:
applying a water blocking material in and around the cable core;
applying one or more strength yarns around the cable core; and
optionally embedding one or more strength members within the outer sheath during application of the outer sheath.

27. The method of claim 26, wherein:
the water blocking material is selected from a water-swellable yarn, water-swellable tape;
the one or more strength yarns is selected from aramid yarn, glass yarn; and
the one or more strength members is selected from fibre-reinforced plastic (FRP), aramid reinforced plastic (ARP), metallic rods.

28. An optical fibre cable comprising:
an outer sheath; and
a cable core disposed within the outer sheath, the cable core comprising at least one optical fibre ribbon according to claim 1, wherein the at least one optical fibre ribbon comprises:
a plurality of optical fibres arranged substantially parallel to each other along a longitudinal direction and across a ribbon width; and
a bonding material disposed between adjacent optical fibres to form a plurality of bonding regions,
wherein the plurality of bonding regions are:
distributed intermittently along the longitudinal direction, and
arranged across the ribbon width such that bonding regions at one or more edge portions have greater bond length than bonding regions at one or more central portions.
